(19) United States
(12) Patent Application Publication
(10) Pub. No.: US 2012/0310910 A1
(43) Pub. Date: Dec. 6, 2012

(54) Method of Data Fusion and Providing Information in a Computer System

(75) Inventors: Claudia Haubach-Lippmann, Landshut (DE); Thomas Burger, Brunnthal (DE); Harald Neujahr, Markt Schwaben (DE); Milton Amador, Muenchen (DE)

(73) Assignee: EADS Deutschland GmbH, Ottobrunn (DE)

(21) Appl. No.: 13/486,600

(22) Filed: Jun. 1, 2012

(30) Foreign Application Priority Data
Jun. 3, 2011 (DE) 10 2011 103 305.3

(51) Int. Cl. G06F 17/30

(52) U.S. Cl. 707/705; 707/E17.01; 707/E17.019

(57) ABSTRACT

A method of data fusion and providing information in a computer system regarding the performance of work tasks on a technical product is provided. Product information on the technical product from a product information database, image information from an image information database and work process information from a work process database are assembled in the computer system to form a data set of a fused process instruction. This data set is processed to form a combined display file that is sent to a display unit, whereupon the fused process instruction is displayed in an optically visible manner.

### TECHNICAL FIELD

The present invention relates to a method of data fusion and providing information in a computer system regarding the performance of work tasks on a technical product. The invention further relates to a computer system for carrying out a method of this type.

### BACKGROUND OF THE INVENTION

In carrying out work tasks on highly complex technical systems, such as aircraft, for example, there is a problem in providing the persons involved in carrying out the work task with adequate instructions for the work steps to be carried out.

### PRIOR ART

Until now usually printed or electronically available manuals have been available for this purpose, in which the work steps are described textually, this description being generally supplemented by illustrations. This type of description in manuals of work steps are always based on a defined initial state of the product on which the work steps are to be carried out. This means that after the completion of the actual work step, for example, a repair measure, further work steps have to be carried out in order to reestablish this initial state. Even if after this a similar work task is to be solved in the same region of the product, some work steps have to be carried out again. This approach is necessary when logging the activities carried out to be able to designate all of the work steps specified in the manual as having been completed.

For example, if a device hidden in a cavity behind a fuselage flap is to be replaced on an aircraft, first the fuselage flap must be opened, subsequently the device must be replaced and the fuselage flap must be closed again. If another task is scheduled, in which in the same cavity section of the fuselage another repair measure is to be carried out which, for example, is carried out by a team specialized in other activities, again the fuselage flap must first be opened in order to reach the cavity. Such activities, necessary for reasons of safety but carried out twice, increase the necessary working time and thus the cost.

Furthermore, it is laborious and expensive to produce manuals for highly complex technical products and in particular to prepare drawings for this purpose. Finally, manuals of this type, which have a static representation of work processes, are subject to a very high maintenance requirement and the search times that are necessary in order to identify the steps to be carried out for a work task are often very long.

It would therefore be desirable if an always updated work that is also adapted to current requirements were available, which provides a person working on the product with the necessary information individually. This is preferably carried out electronically, wherein many suitable data are already available in different databases.

### DESCRIPTION OF THE INVENTION

Exemplary embodiments of the present invention provide a method for data fusion and providing information in a computer system regarding the performance of work tasks on a technical product, which is able, using information already available in different databases, to assemble the information necessary for carrying out a work task on the technical product in a case-specific manner and to make it available to the persons carrying out the work task as a dynamically generated display.

This method according to the invention for data fusion and providing information in a computer system regarding the performance of work tasks on a technical product involves product information on the technical product from a product information database, image information from an image information data base and work process information from a work process database to be assembled in the computer system to form a data set of a fused process instruction and that this data set is processed to form a combined display file that is sent to a display unit, whereupon the fused process instruction is displayed in an optically visible manner.

According to the invention the product information on the technical product from a product information database, image information from an image information database and work process information from a work process database is merged in the computer system to form a data set of a fused process instruction.

For example, the product information on the respective technical product stored in the product information database contains information on the equipment of the specific product to be processed. Thus, when the technical product to be processed is provided with special equipment features, these are stored in the product information database and are taken into consideration in the process instruction provided by means of the data fusion.

The image information database also contains image information that comprises all possible equipment variants, for example, as engineering structural drawings.

Finally, textual instructions for work processes to be carried out for all possible embodiment variants of the technical product are stored in the work process database.

In the data fusion, work process information from the work process database and image information from the image information database are retrieved on the basis of the product information, and this information is merged to form a fused process instruction. This data set is subsequently processed to form a combined display file, on the basis of which the process instruction with text and image, taking into consideration the product-specific properties, is then displayed in an optically visible manner.

An example, a work task is replacing a heater core in the heating system of a motor vehicle will now be described. By querying the product information database, the specific equipment features of this motor vehicle are retrieved and it is established, for example, that this motor vehicle is equipped with an air conditioning system and that a cooling system heat exchanger is provided from the heater core. With this product information, work process information is then retrieved from the work process database, which gives the person working on the motor vehicle first the instruction to remove the cooling system heat exchanger and retrieves the work steps necessary for this in text form. Furthermore, corresponding image information is retrieved from the image information database, which contains the equipment state of this motor vehicle, namely with cooling system heat exchanger. The fused textual work process information and image information is shown on the display unit, and the person working on the motor vehicle can see immediately how first he should remove the cooling system heat exchanger. Following this, when these work steps have been completed, in a new phase of the process the steps are shown and described that are necessary for removing the heater core. This very simple example shows that product-specific work information can be generated with the method according to the invention by the dynamic generation of the process instruction.

Of course, this method can be used not only for the purpose of maintenance, but just as well during the production of a complex technical product or, for example, when retrofitting or converting this product.

### Advantages

A special advantage of the method according to the invention for data fusion and for providing information in a computer system regarding the performance of work tasks on a technical product thus lies in that the work instructions do not have to be read in statically produced manuals, but are generated and displayed dynamically in a product-specific and even situation-specific manner.

A particularly advantageous embodiment of the method according to the invention is characterized by the following steps:

a) Specification of a work task on an object of the technical product to be processed by an operator by means of an input device of the computer system;

b) Identification of the work task in the data stock of the work process database by the computer system;

c) Provision
Of product identification data regarding the product on which the work task is to be carried out,
Of object identification data of the object to be processed and
Of work task identification data regarding the work task to be carried out as a group of work process data modules in a random access memory of the computer system;

d) Determination of involved assemblies and/or components in the product information database by the computer system by means of
The work task identification data based on the provided work process data modules,
The linking information respectively contained in the work process data modules,
The product identification data and
The object identification data;

e) Identification of a work process data module in the work process database by means of the product identification data, the object identification data and the work task identification data from the group of the work process data modules and selection of the identified work process data module;

f) Identification of a work task data module contained in the identified work process data module by means of the product identification data, the object identification data and the work task identification data;

g) Retrieval of the work step instruction data from the work task data module identified in step f) in text form from the work process database and storage of the work step instruction data in the random access memory of the computer system;

h) Retrieval of product information data of the technical product from the product information database by means of the linking information contained in the work process data module identified in step e) and storage of the product information data in the random access memory of the computer system;

i) Retrieval of image information data of assemblies and/or components of the technical product assigned to the work task data module identified in step f) from the image information database by means of the linking information contained in the work process data module identified in step e) and storage of the image information data in the random access memory of the computer system;

j) Fusion of the work step instruction data stored in the random access memory in text form with the product information data stored in the random access memory and the image information data stored in the random access memory by automatic linking in the computer system to a display file forming a fused process instruction and

k) Sending the display file to a display unit of the computer system for showing the fused process instruction for one of the work steps to be carried out within the work task.

This special embodiment of the method according to the invention shows those steps that can be carried out in order to obtain the desired fused process instruction in a very particularly advantageous manner. To refine the product information, object identification data are also stored in the product information database so that special individual object properties of the object to be processed (for example, the above-referenced heater core) are also incorporated into the generation of the process instruction. Thus, in the above-referenced example of the motor vehicle, the heating system can be provided with a thermostatic control, which is why the heater core has an electric temperature sensor, so that the corresponding electric line has to be marked off before the removal.

The modular structure of the work task identification data as group of work process data modules makes it possible to select and combine relevant work process data modules depending on the product identification data and the object identification data. In this manner a number of process instructions are dynamically assembled depending on the specific embodiment of the product and of the object to be processed.

The individual work step instructions are then read out from the respective work task data module as data elements and ultimately shown sequentially on the display unit in text form and reinforced by corresponding image representations.

It is also advantageous if the method involves
The product information electronically stored in the product information database having information on assemblies and/or components of the technical product;
The image information electronically stored in the image information database having information on assemblies and/or components of the technical product;
The work process information electronically stored in the work process database containing as first information units work process data modules on a plurality of work tasks, which in turn as second information units have work task data modules, which in turn contain work step instruction data and
The work process data modules have linking information, in particular relations, on the technical product, in particular on the assemblies and/or components thereof, and on image information.

This structure of the contents of the individual databases is particularly suitable for generating in a dynamic manner the necessary process instructions to be displayed.

It is also advantageous if the product information database, in addition to general product information, also contains current product status information and if both sets of information are contained in the product information data retrieved in step h).

This further development of the method according to the invention makes it possible to include the current product condition in the generation of the fused process instructions. For example, if several working groups are working on the product or object to be processed, it can occur that a first working group already has carried out certain preliminary work that is necessary for accomplishing their work task and that the same preliminary work would also be necessary for carrying out the work task of the second working group. According to the method according to the invention, according to this further development the product condition documented by the first working group is taken into consideration in the compilation of the process instructions for the second working group, so that they immediately see that certain work tasks, for example, the removal of a cladding, have already been carried out and no longer have to be completed by them.

It is furthermore particularly preferred if identification information is determined and included in a semantic or ontology-based manner for the identification of the
Work process data module in step e) and/or
Work task data module in step f) and/or
Product information data to be retrieved in step h).

This semantic or ontology-based determination of the identification information has the advantage that the generation of the fused process instruction can be carried out not only by means of the rigid reference information (relations) stored in the individual files, but also by the evaluation of connections in an autonomous intelligent manner.

It is particularly preferred if the image information stored in the image information database has three-dimensional information. In this manner it is possible to rotate the image data drawn upon for the fusion of the process instruction on the display device into a suitable perspective for the operator before display. It is also particularly advantageous if the operator himself/herself can cause this rotation by means of acting on a corresponding control device of the computer system and thus is able to rotate the image shown on the display unit.

Preferably, the image information stored in the image information database comprises CAD information. This taking over of CAD information already available from the construction of the product or of the object makes it possible to provide the necessary image information without the preparation of additional drawings or sketches and thus saves on expense compared to conventional manuals that contain such specially prepared sketches and drawing.

It is particularly advantageous when an image representation correlated to the product information data is produced in the fusion of the image information stored in the random access memory with the work step instruction data and the product information data for a fused process instruction in step j) from the image information data stored in the random access memory, which image representation is included into the display file. This special correlation between image information data and product information data makes it possible to generate a product-specific image representation.

It is also particularly advantageous if the sequence of the process steps a) through k) is executed in parallel at the same time or offset to one another in terms of time for several operators who are carrying out different work tasks on the product at the same time. This variant of the method according to the invention increases the dynamization of the process instructions displayed to the individual operators, since not only the change status produced by their own work on the product is taken into consideration in the data fusion, but the changes made to the product by the other operators are also included in the data fusion.

It is particularly advantageous if after a work step has been carried out according to the displayed process instruction, the completion of the work step is entered manually or automatically via an input device into the random access memory of the computer system and that the computer system thereupon updates the product status information in the product information database. This logging of work steps carried out in the computer system and as a result in the product information database ensures that the current status of the product is always documented and is drawn upon as a basis for the further process instructions to be generated.

A particularly advantageous further development of the method according to the invention involves general knowledge information on the product being stored in a knowledge database, which is provided in the random access memory of the computer in step c), and that these data are taken into consideration in the identification of the work process data module in step e) and of the work task data module in step f). The additional consideration of such general knowledge information on the product is advantageous when the product has certain properties, which, for example, have been caused by changes in the product or by accident-related repair measures and which are to be taken into consideration in carrying out certain work on the product.

Finally, it is also very advantageous when furthermore resource information data on resources available for performing the work task are stored in a resource database, which is provided in step c) in the random access memory of the computer, and if these data are also taken into consideration in the identification of the work process data module in step e) and of the work task data module in step f). This additional consideration of resource information data can mean, for example, that the process instructions are influenced depending on certain resources available at the work site. Thus, for example, the information can be provided that certain special tools are available or are not available or that certain specialists are available on site to deal with special work steps. For example, if the resource information is provided that a specialist is available for the repair of certain instruments, for example a work instruction can be emitted on how to proceed when repairing the instrument, whereas if a specialist is not available, the work instruction appears to replace the respective instrument completely.

Particularly preferably the method according to the invention is used when the work task is a task on one or more of the following fields of activity:
Production of the product.
Maintenance of the product,
Repair of the product,
Restoration of the product,
Retrofitting or conversion of the product,
Backfitting of the product,
Decommissioning of the product,
Recycling of the product.

In all of these activities—as well as many other conceivable more complex work on a product—it is possible to proceed very efficiently by means of the method according to the invention.

To carry out the method according to the invention preferably a computer system is provided with a computer that has an input device, a display unit and at least one random access memory, as well as a product information database, an image information database, a work process database and technical information magazine having a relation database. For this purpose, the computer system has software stored in a memory that implements the method according to the invention and which can be run or runs on the computer.

Preferably, the computer system furthermore can have a knowledge database and/or a resource database.

Preferred exemplary embodiments of the invention with additional design details and further advantageous are described and explained in more detail below with reference to the attached drawings.

### BRIEF DESCRIPTION OF THE DRAWINGS

FIG. 1 is a diagrammatic representation of a complex technical product with superimposed semantic information network;

FIG. 2 is a diagrammatic representation of a data processing device for carrying out the method according to the invention;

FIG. 3 is a diagrammatic representation of a lining up in a row of work process data modules and

FIG. 4 is a diagrammatic process representation of work process data modules coupled to one another.

### DESCRIPTION OF PREFERRED EXEMPLARY EMBODIMENTS

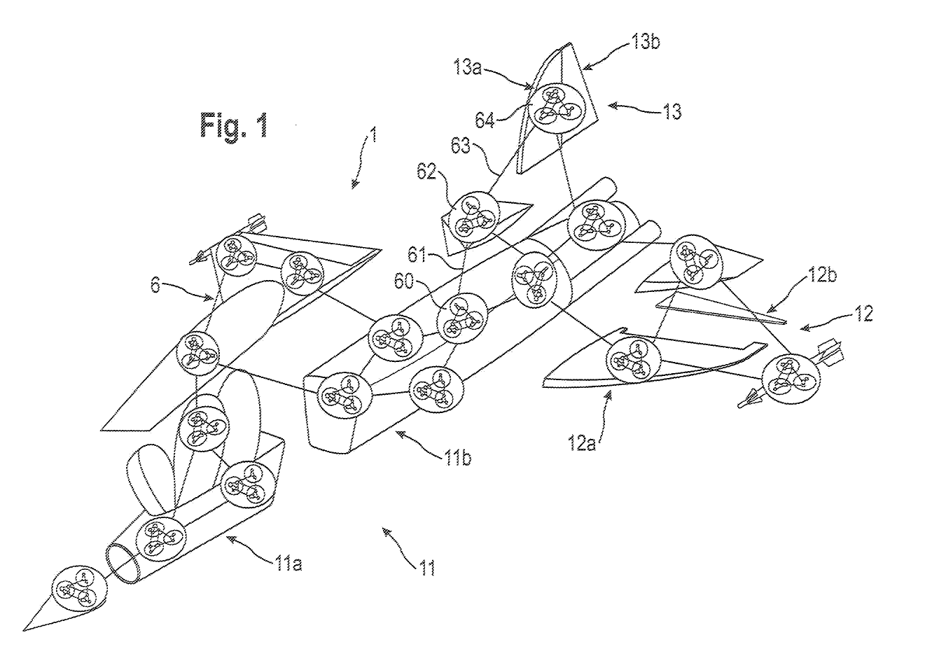

FIG. 1 shows as technical product 1 as defined by the invention an aircraft taken apart into individual assemblies 11, 12, 13, wherein the assemblies 11, 12, 13 in turn are subdivided into components 11a, 11b; 12a, 12b; 13a, 13b. Thus, the aircraft 1 shown, for example, is subdivided into the assemblies of the fuselage 11, the lift surfaces 12 and the tailplane 13. The fuselage, for example, is further subdivided into a front fuselage section 11a and a rear fuselage section 11b. The lift surfaces 12 are divided, for example, into a wing 12a and an aileron 12b. The tailplane 13, for example, is subdivided into a stationary tailplane 13a and a rudder plane 13b. The division of the aircraft into assemblies and components described here is given merely by way of example. It is obvious to a person skilled in the art that a complex technical product, such as an aircraft, can be divided into a plurality of further assemblies and components.

This structure of the physical product aircraft forms the model core for a semantic layer of metadata information on the product. This semantic layer is shown in FIG. 1 by a semantic network 6, which has individual information pools 60, 62, 64 that are connected to one another via semantic associations 61, 63. At least one information pool is thereby assigned to each assembly of the product.

These information pools respectively contain a plurality of information elements on the corresponding assembly of the aircraft 1. The information contained in the information elements comprises data that are stored in different databases. These data, for example, are hierarchically structured data of the aircraft, individual aircraft assemblies and individual aircraft components. These metadata of the product aircraft are electronically stored in a product information database 100. Furthermore, image information on the aircraft, the individual assemblies of the aircraft and the components of the aircraft is contained in the information elements, wherein this image information comprises the image information data that are electronically stored in an image information database 200.

The metadata of the product stored in the product information database 100 with their relations among one another and the image information data stored in the image information database with their relations are merged in the semantic network to form a relation network between product information data and image information data and in this manner form a superordinate relation database (metadata repository) as a product data management system PDM, wherein the individual data, however, remain in the original databases (product information database 100 and image information database 200). This PDM relation database thus does not contain the content data, but only links to the memory locations of the data stored in the product information database 100 and the image information database 200.

Furthermore, a work process database 300 is provided, in which work process information for activities to be carried out on the product is stored.

A common technical information repository CTIR on the aircraft, thus on the technical product, comprises a CTIR database in which data are contained for referencing the product data management system PDM and thus the references stored therein to the metadata stored in the product information database 100 and in the image information database 200 for describing the product and data for referencing the metadata for describing the work processed, which link to the work process data stored in the work process database 300. The CTIR database is thus likewise a relation database, in which pointers are stored that link indirectly via the PDM or directly to the content databases (product information database and image information database or work process database).

A knowledge database 400 with general knowledge information on the product stored therein and/or a resource database 500 in which resource information data on resources available for the performance of the work task are stored can be connected in an analogous manner to the common technical information repository CTIR. A system of this type of the common technical information repository CTIR and external content databases can easily be expanded by further external databases and relation information to these further databases stored in the CTIR database.

Alternatively, it is also possible to embody the common technical information repository CTIR as a data warehouse, wherein the contents of the product information database 100, the image information database 200, the work process database 300 and preferably also the knowledge database 400 and/or the resource database 500 are then contained in the CTIR database.

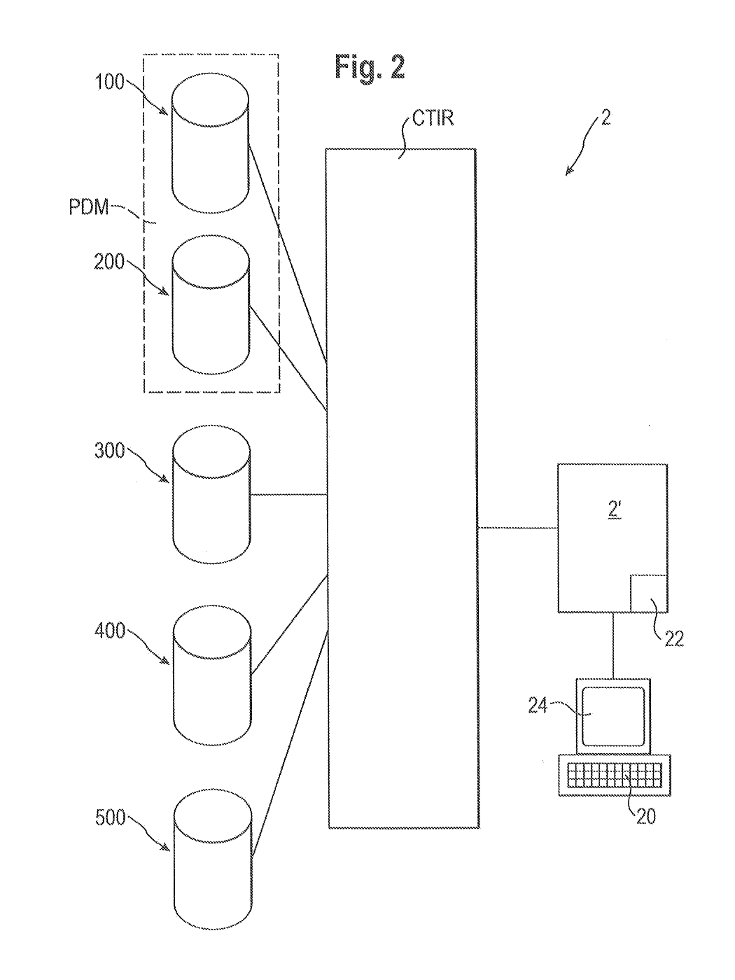

FIG. 2 shows in a simplified manner the interaction of the different databases in carrying out the method according to the invention. The above-mentioned metadata of the product with their relations to one another are stored in the product information database 100. Image information data on the product with their relations are stored in the image information database 200. For example, image information data of this type are the CAD model data originating from the construction of the product. The product information database 100 and the image information database 200 are connected to the PDM relation database of the product management system PDM for data exchange.

A computer 2′, the product information database 100, the image information database 200, the work process database 300 and the CTIR database, which links to the work process database 300 and the PDM relation database and thus indirectly to the product information database 100 and the image information database 200, form a computer system 2 on which the method according to the invention runs. In addition, the knowledge database 400 and/or the resource database 500 can also be integrated into the computer system, wherein the CTIR database then also contains references to these databases.

A computer program that implements the method according to the invention and runs on the computer 2′, retrieves from the product information database 100 product information on the technical product 1, that is, in the exemplary case on the aircraft, as well as image information on this from the image information database 200. Furthermore, for a predetermined work process entered at the start via an input device 20, work process information from the work process database 300 is retrieved. This information, the product information, the image information and the work process information is loaded on a random access memory 22 of the computer 2′. The program running on the computer 2′ merges the product information data and image information data temporarily stored in the random access memory 22 of the computer 2′, using the work process information, to form a fused process instruction in the form of a data set. This data set is then processed to form a combined display file, which is sent by the computer 2′ to a display unit 24 and there is displayed in an optically visible manner. This displayed process instruction contains text work process information as well as an assigned image representation. Based on this fused process instruction displayed to the user, the user can read which work steps he/she has to carry out and he/she can see in the image representation where and how he has to complete these work steps. Once the user has completed the work steps, he enters a confirmation via the input device 20 of the computer 2′.

This approach according to the method according to the invention in detail proceeds as follows:

First, the operator enters a work task that has been stipulated for him/her on an object to be processed of the technical product 1 by means of the input device 20 of the computer 2′ embodied, for example, as a keyboard or as a touch-sensitive screen. The computer 2′ thereupon identifies the work task in the data pool of the work process database 300. Product identification data regarding the technical product 1 on which what work task is to be carried out as well as object identification data of the object to be processed and work task identification data regarding the work task to be carried out are provided by the product information database 100 or the work process database 300 in the random access memory 22 of the computer 2′. The work task to be carried out is formed as a group of work process data modules.

Based on these provided data, the assemblies and/or components involved in the activities to be carried out are determined in the provided data of the product information database by the computer 2′ by means of the work tasks identification data based on the provided work process data modules, the linking information respectively contained in the work process data modules, the product identification data and the object identification data. From the work process data modules provided in the random access memory 22, a work process data module is identified and selected by means of the product identification data, the object identification data and the work identification data. Within this identified work process data module, a work task data module is identified from a plurality of work task modules contained in the work process data module by means of the product identification data, the object identification data and the work task identification data. From this identified work task data module, work step instruction data, which are encoded in the identified work task data module, are then retrieved in text form from the work process database 300 and temporarily stored in the random access memory 22 of the computer 2′.

Furthermore, by means of the linking information contained in the identified work process data module, product information data of the technical product is retrieved from the product information database and these product information data are likewise temporality stored in the random access memory 22 of the computer 2′.

Furthermore, image information data on the assemblies and/or components of the technical product which are assigned to the identified work task data module, are retrieved from the image information database. This retrieval of the image information data is carried out by means of the relations contained in the identified work process data module. The image information data retrieved are likewise temporarily stored in the random access memory 22 of the computer 2′.

In a next step, the work step instruction data, which are available in text form, stored in the random access memory 22 of the computer 2′ are assembled with the product information data stored in the random access memory 22 and the image information data stored in the random access memory 22 to form a display file forming a fused process instruction, which is carried out by the automatic linking of the respective data to one another on the basis of the linking information. This display file is then sent to the display unit 24 of the computer 2′ and the fused process instruction for one of the work steps to be carried out within the work task is visibly displayed on the display unit 24 for the operator.

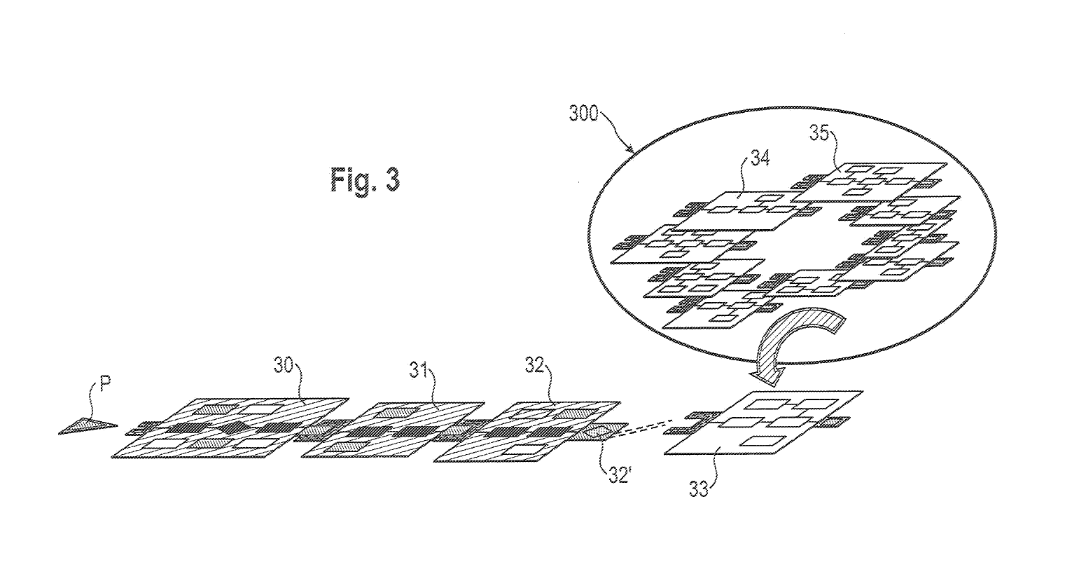

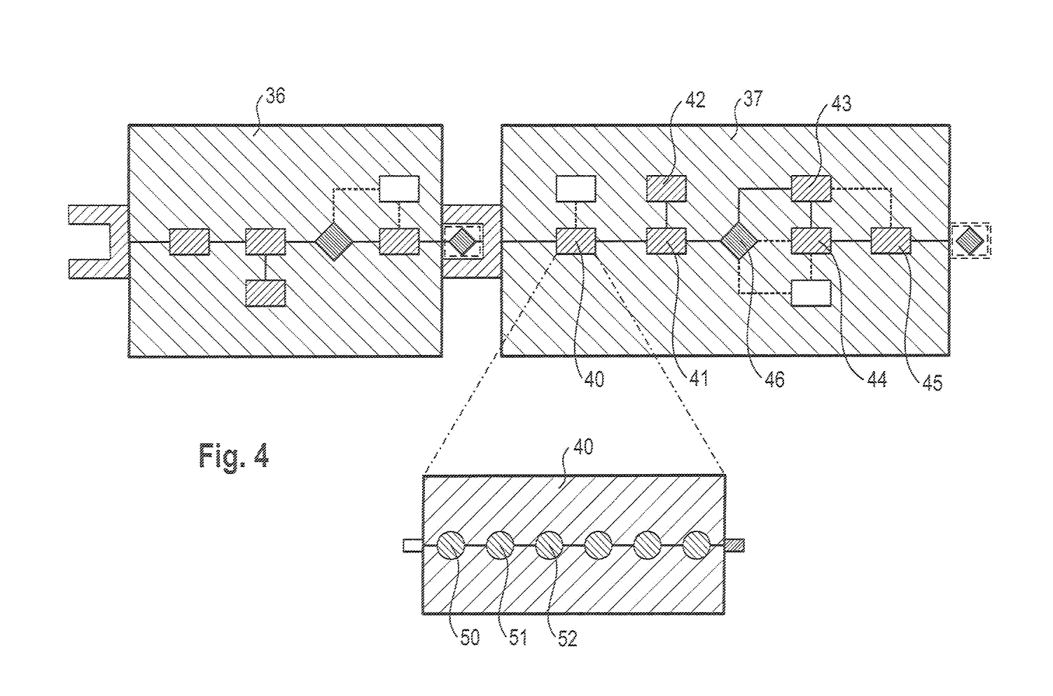

FIG. 3 shows by way of example the modularity of the work process information stored in the work process database 300. These work process data modules 30, 31, 32, 33, 34, 35, 36, 37, as has already been described, are identified and singled out by means of the product information data, the object identification data and the work task identification data from the stock of the work task data modules stored in the work process database 300 and linked to one another for the sequence of the activity to be carried out on the technical product 1. This operation is illustrated in FIG. 3. The progress of the activity to be carried out is symbolized by arrow P. The work process data modules 30, 31 and 32 have already been assembled. The last added work process data module 32 contains at its free end a decision element 32′. Depending on the decision reached therein on the continuation of the method, the suitable work process data module 33 is selected from the stock present in the work process database 300 of work process data modules 33, 34, 35 and added to the work process data module 32. Thereupon the work task data modules contained in the work process data module 33 corresponding to step f) of the method according to the invention are identified, as is shown based on FIG. 4 in the work process data module 37.

The work process data module 37 contains a plurality of work task data modules 40, 42, 43, 44, 45, which are linked to one another either consecutively or alternatively via decision points 46. Decision points can also be provided within a work task data module, as is discernible in the representation of the data modules 43 or 44.

Based on the work task data module 40, shown enlarged in FIG. 4, it can be seen that each work task data module has a plurality of work step instruction data 50, 51, 52, which as a rule have to be processed one after the other, wherein, as has been said, an earlier exit from the work task data module is also possible here, as can be seen based on the data modules 43, 44.

Reference numbers in the claims, the specification and the drawings are used merely for a better understanding of the invention and are not intended to restrict the scope of protection.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of data fusion and providing information in a computer system regarding the performance of work tasks on a technical product, the method comprising:
assembling, by the computer system, product information on the technical product from a product information database, image information from an image information database and work process information from a work process database to form a data set of a fused process instructions; and
processing, by the computer system, the data set of the fused process instructions to form a combined display file;
sending, by the computer system, the combined display file to a display unit, which displays the fused process instruction in an optically visible manner.

2. The method according to claim 1, further comprising:
a) receiving, from an operator by an input device of the computer system, a specification of a work task on an object of the technical product to be processed;
b) identification, by the computer system, of the work task in the data stock of the work process database;
c) providing, in a random access memory of the computer system, product identification data regarding the product on which the work task is to be carried out, object identification data of the object to be processed or work task identification data regarding the work task to be carried out as a group of work process data modules;
d) determining, by the computer system, involved assemblies or components in the product information database by the computer system by means of
the work task identification data based on the provided work process data modules,
the linking information respectively contained in the work process data modules,
the product identification data, or
the object identification data;
e) identification a work process data module in the work process database by the product identification data, the object identification data and the work task identification data from the group of the work process data modules and selection of the identified work process data module;
f) identifying a work task data module contained in the identified work process data module by the product identification data, the object identification data and the work task identification data;
g) retrieving the work step instruction data from the work task data module identified in step f) in text form from the work process database and storing the work step instruction data in the random access memory of the computer system;
h) retrieving product information data of the technical product from the product information database by the linking information contained in the work process data module identified in step e) and storing of the product information data in the random access memory of the computer system;
i) retrieving image information data of assemblies or components of the technical product assigned to the work task data module identified in step f) from the image information database by the relations contained in the work process data module identified in step e) and storage of the image information data in the random access memory of the computer system;
j) fusing the work step instruction data stored in the random access memory in text form with the product information data stored in the random access memory and the image information data stored in the random access memory by automatic linking in the computer system to a display file forming a fused process instruction; and
k) sending the display file to the display unit of the computer system to show the fused process instruction for one of the work steps to be carried out within the work task.

3. The method according to claim 2, wherein
the product information electronically stored in the product information database has information on assemblies or components of the technical product;
the image information electronically stored in the image information database has information on assemblies or components of the technical product;
the work process information electronically stored in the work process database contains as first information units work process data modules on a plurality of work tasks, which in turn as second information units have work task data modules, which in turn contain work step instruction data; and
the work process data modules have linking information, in particular relations, on the assemblies or components thereof, and on image information.

4. The method according to claim 2, wherein the product information database, in addition to general product information, also contains current product status information and that both sets of information are contained in the product information data retrieved in step h).

5. The method according to claim 2, wherein identification information is determined and included in a semantic or ontology-based manner for identification of
the work process data module in step e),
the work task data module in step f), or
the product information data to be retrieved in step h).

6. The method according to claim 1, wherein the image information stored in the image information database has three-dimensional information.

7. The method according to claim 1, wherein the image information stored in the image information database comprises CAD information.

8. The method according to claim 2, wherein an image representation correlated to the product information data is produced in the fusion of the image information stored in the random access memory with the work step instruction data and the product information data for a fused process instruction in step j) from the image information data stored in the random access memory, which image representation is included in the display file.

9. The method according to claim 2, wherein the sequence of the process steps a) through k) is executed in parallel at the same time or offset to one another in terms of time for several operators who are carrying out different work tasks on the product at the same time.

10. The method according to claim 2, wherein a work step has been carried out according to the displayed process instruction, completion of the work step is entered manually or automatically via an input device into the random access memory of the computer system and that the computer system thereupon updates the product status information in the product information database.

11. The method according to claim 2, wherein general knowledge information on the product is stored in a knowledge database provided in the random access memory of the computer in step c), and the stored general knowledge information is taken into consideration in the identification of the work process data module in step e) and of the work task data module in step f).

12. The method according to claim 2, wherein resource information data on resources available for performing the work task are stored in a resource database, which is provided in step c) in the random access memory of the computer system, and the resource information data are also taken into consideration in the identification of the work process data module in step e) and of the work task data module in step f).
